(19) United States
(12) Patent Application Publication
(10) Pub. No.: US 2026/0225641 A1
(43) Pub. Date: Aug. 6, 2026

(54) VEHICLE HAND BRAKE AND HAND THROTTLE CONTROL SYSTEM

(71) Applicant: VEHICLE ENGAGEMENT TECHNOLOGIES, LLC, Columbia, SC (US)

(72) Inventors: John Jesse STUBBS, Braintree (GB); Sean Francis MCREE, Columbia, SC (US)

(73) Assignee: VEHICLE ENGAGEMENT TECHNOLOGIES, LLC, Columbia, SC (US)

(21) Appl. No.: 19/151,052

(22) PCT Filed: Jan. 25, 2024
(86) PCT No.: PCT/US2024/012958

§ 371 Date: Jul. 25, 2025

Related U.S. Application Data
(60) Provisional application No. 63/441,499, filed on Jan. 27, 2023.

(51) Int. Cl. B62D 1/04; B60K 26/02; B60T 7/04; B60T 7/08; B62D 1/06; G05G 1/01

(52) U.S. Cl. CPC B62D 1/046; B60K 26/02; B60T 7/085; B62D 1/06; G05G 1/01; B60K 2026/025; B60K 2026/028; B60T 7/04; B60T 2220/04

(57) ABSTRACT

A vehicle having a steering wheel with an outer cover operable to twist in at least one of a first direction and a second direction. The vehicle further including a braking system and a throttle system, the braking system is operable to at least one of decrease the speed of the vehicle and stop the while the throttle system is operable to increase the speed of the vehicle. The vehicle further having at least one controller programed to, in response to twisting the steering wheel outer cover in the first direction, operate the throttle system to increase the speed of the vehicle, and in response to twisting the steering wheel outer cover in the second, direction, operate the braking system to decrease the speed of the vehicle.

### CROSS-REFERENCE TO RELATED APPLICATIONS

This application claims the benefit of U.S. provisional application Ser. No. 63/441,499 filed Jan. 27, 2023, the disclosure of which is hereby incorporated in its entirety by reference herein.

### TECHNICAL FIELD

The present disclosure relates to a vehicle brake and throttle override and control system.

### BACKGROUND

Motor vehicles are typically controlled by a steering wheel assembly separate from foot actuated brake and throttle assemblies. The throttle assembly controls the amount of fuel that goes into an engine or in the case of an electric vehicle the amount of power that is delivered to a drive assembly to propel the vehicle based on a force applied to a throttle pedal or other known throttle input. The brake assembly controls the stopping power of the vehicle by slowing the vehicle when a force is applied to a brake pedal, which in turn forces a hydraulic or electric braking system to be engaged. The steering assembly includes a steering wheel, positioned in front of the operator allowing the operator to rotate the steering wheel in a clockwise or counterclockwise rotation to turn the motor vehicle right or left using an operator's hands. Typically, the throttle pedal and the brake pedal are located on a floor of the motor vehicle and typically include a cable or linkage to transfer linear movement of the pedals to activation of the throttle and brake assemblies. They may also be connected to sensors operable to transfer the linear movement electronically to the brake and throttle assemblies via an Electronic Control Module (ECM) as is commonly used in the automotive industry. The steering wheel may also be connected through a shaft to a steering pump to translate the rotational movement of the steering wheel to a linear movement of the steering linkage to ultimately angle the tires and turn the vehicle or the steering wheel may be connected either electronically or hydraulically to translate the rotational movement of the steering wheel to linear movement of the steering linkage to direct the vehicle tires in the desired directions.

However, in the case of a driver having a disability or a driver who becomes incapacitated, foot actuated gas and brake controls may be difficult, if not impossible to use. Known disability adaptation systems connected to the steering wheel or steering column can be cumbersome and ineffective in some situations. Accordingly, there is a need for a robust, reliable and easy to activate and deactivate control assembly that will allow a user to operate the throttle and braking systems through the steering wheel assembly without adding the cumbersome devices protruding from the steering wheel or steering column from multiple positions within the vehicle.

### SUMMARY

A vehicle having a steering wheel with an outer cover operable to twist in at least one of a first direction and a second direction is disclosed. The vehicle having a braking system operable to at least one of decrease a speed of the vehicle and stop the vehicle and a throttle system operable to increase the speed of the vehicle. The vehicle further having a controller programmed to, in response to twisting the steering wheel outer cover in the first direction, operate the throttle system to increase the speed of the vehicle, and in response to twisting the steering wheel outer cover in the second direction, operate the braking system to decrease the speed of the vehicle.

A steering wheel having a center hub configured to attach to a vehicle and at least one steering spoke extending outward from the center hub and configured to support at least one steering wheel core extending at least partially radially around a central axis of the center hub. The steering wheel further includes at least one twist assembly positioned about the at least on steering wheel core. The twist assembly is operable to twist about the steering wheel core in at least one of a first direction and a second direction, the second direction opposite the first direction. Movement of the twist assembly in the first direction increases a speed of the vehicle and movement of the twist assembly in the second direction decreases the speed of the vehicle is disclosed.

A steering wheel having throttle and brake control integrated into a steering wheel twist grip surface is disclosed. The integrated control may be activated using a control activation device mounted on a surface of the steering wheel, the steering column or other location accessible within a vehicle cabin. Once the control activation device is activated or engaged an operator is able to grab the steering wheel grip surface and rotate the grip in a clockwise or a forward rotational motion relative to a natural position of the steering wheel of a motor vehicle to activate the vehicle throttle. The user may also rotate the steering grip counterclockwise or in a backward rotational motion to activate the vehicle brakes. This can be done from the passenger seat, rear seat or any other location of the motor vehicle to at least one of accelerate and stop the vehicle by anyone in the vehicle cabin from any adjacent position.

A method of operating a motor vehicle with a twist grip steering assembly is disclosed. The steering assembly includes a steering wheel attached to a motor vehicle, the steering wheel having a hub, a steering wheel core connected to the hub, a torsional member positioned around the steering wheel core, a twist grip positioned around and connected to the torsional member, an encoder operatively connected to at least one of the torsional member and the twist grip and a controller operatively connected to the encoder. The method includes the step of twisting the twist grip in at least one of a first direction thereby rotating the encoder in a first direction to generate an acceleration signal and sending the acceleration signal to at least one of the controller and a servo motor in communication with an accelerator to accelerate the vehicle. Further the method includes the step of twisting the twist grip in at least one of a second and opposite direction to the first direction thereby rotating the encoder in a second and opposite direction to generate a braking signal and sending the braking signal to at least one of the controller and the servo motor to brake the vehicle.

A method of controlling both foot brake and gas pedal through a twist grip steering wheel is also disclosed. The twist grip steering wheel may be operable to activate the brake pedal or the accelerator pedal through a single rotary motor receiving a positional control from the clockwise or counterclockwise movement of the steering wheel twist grip surface. The method of operation allows an operator to enable control of the motor vehicles direction and speed and braking using one hand from a position other than the driving seat.

### BRIEF DESCRIPTION OF THE DRAWINGS

FIG. 1 illustrates a side view of an exemplary vehicle hand brake and hand throttle control system with steering wheel and pedal assemblies in a vehicle;

FIG. 2 illustrates an isometric view of an exemplary vehicle hand brake and hand throttle control system with steering wheel in partial cut-away and pedal assemblies of FIG. 1;

FIG. 3 illustrates a front view of an exemplary steering wheel assembly, as illustrated in FIG. 1 and FIG. 2, where the steering wheel assembly is partially cut-away;

FIG. 4 illustrates an isometric view of the exemplary cut-away steering wheel assembly rear side, as illustrated in FIG. 3;

FIG. 5 illustrates a detail view of a twist bearing and rotary encoder mechanism of the exemplary steering wheel assembly, as illustrated in FIG. 4;

FIG. 6 illustrates an exploded perspective view of the exemplary steering wheel assembly as illustrated in FIG. 4;

FIG. 7 illustrates a detail view of the steering wheel spoke and drive belt assembly of FIG. 4;

FIG. 8 illustrates a detail view of the drive belt assembly of FIG. 4;

FIG. 9 illustrates a perspective view of an alternative exemplary steering wheel assembly where the steering wheel assembly is partially cut-away;

FIG. 10 illustrates a rear side perspective of the alternative exemplary steering wheel assembly of FIG. 9;

FIG. 11 illustrates a detail view of the alternative exemplary steering wheel assembly of FIG. 10;

FIG. 12 illustrates a perspective view of an alternative exemplary steering wheel assembly;

FIG. 13 illustrates a partial exploded and cut-away view of the alternative exemplary steering wheel assembly of FIG. 12; and

FIG. 14 is a partial exploded and cut-away view of the alternative exemplary steering wheel assembly of FIG. 12.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of specific components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for specific applications or implementations.

An auxiliary brake and acceleration device system, hereinafter the BAD system, having a twist acceleration/deceleration steering wheel that may be operatively connected to an accelerator and brake system of a motor vehicle are disclosed herein. The various exemplary steering wheel designs disclosed herein may include at least an outer rim having and a moveable sleeve positioned about the outer circumference of the twist acceleration/deceleration steering wheel. The outer rim and sleeve may be operable to twist bi-directionally from a central or neutral position, allowing the operation of the accelerator if rotated in a forward or clockwise direction and an operation of the brake when rotated in a rearward or counterclockwise direction for decelerating or braking of the motor vehicle. These forward and rearward directions are merely examples and may be referred to interchangeably as first direction and second direction. It should also be understood that the accelerator may be a twist in the rearward direction while the stopping may be a twist in the forward direction provided that the accelerator engagement is an opposite twist rotational direction opposite of the twist rotational direction of the braking system activation. This change in direction may be dependent on the position or gear selected in a transmission or drive member/prime mover configured in the motor vehicle.

A center or neutral position of the steering wheel rim and sleeve may represent positive a brake once the BAD system is activated by an activation device. Once the activation device is engaged and power is provided to the BAD system a signal may be transmitted to an input to the brake system via a pedal servo, stepper or other known type of drive system, to engage the brake system and hold the motor vehicle from a forward creep from an automatic transmission. This will prevent the motor vehicle from moving if the transmission is engaged when the vehicle's drive system may still be engaged in the event the original operator may be incapacitated. The twist mechanism that allows the outer rim and sleeve to rotate may include a torsional element, such as, but not limited to a coiled spring (in either a single or opposing twin helix design), an elastomeric spring, a metallic or rigid/semi-rigid high shore hardness polymer (round, trapezoidal or rectangular in section) wire or other type of torsional element. It should be understood that any of these torsional elements may be encapsulated or vulcanized in an elastomeric polymer in the form of a tube following the arc of the steering wheel, this encapsulation may form the outer rim or a hand grip of the steering wheel without impeding the rotational aspect of the twist mechanism. Minimizing or stopping losses of rotary motion over the length of the steering will rim when twisted may be achieved by using a non-expandable flexible structural outer and/or inner layer between the coil and the outer elastomeric polymer hand grip or outer rim and central core, which may stop the coils expansion and compressing to eliminate twist losses.

It should be understood and will be apparent from the detailed figures and description listed herein, that the twist may be in the forward and rearward direction of the vehicle around the steering wheel and does not coincide with the left and right rotation of the steering wheel used to turn the car left or right. More specifically, and merely by example, it should be understood that when an operator activates the BAD system and twists the steering wheel in a first direction toward the front of the vehicle, the vehicle may accelerate and propel itself forward or the vehicle may accelerate and propel itself reward depending on the specific gear the transmission direction input is set to. Alternatively, when the operator twists the steering wheel in the opposite or a second direction towards the rear of the vehicle, the vehicle will decrease acceleration while increasing the braking force applied to the brake system thereby decelerating the vehicle or stopping the vehicle fully. Thus, when the twist is increased in the first direction the vehicle will accelerate at a higher speed where the opposite is true when the twist is increased in the opposite or second direction the vehicle may brake more abruptly. Additionally, the BAD system may be fully adjustable in that a ramping may be desired to ease the acceleration engagement as well as the deceleration braking engagement by adjusting the inputs in the ECM such that as more twist is applied the faster the braking and acceleration effect. Conversely when less twist is applied the acceleration or braking may be reduced or ramped down.

Additionally, a self-lubricating polymer, such as, but not limited to a Polytetrafluoroethylene (PTFE) tube may be fitted between the core (the steering wheel rim main structure) and the flexible hand grip, also known as the steering wheel outer rim, to enable smooth rotation. At the points where the outer rim attaches to at least one spoke extending from the central hub of the steering wheel to the steering wheel core, there may be open windows in an inside radius of a twist bearing housing. These windows may also act to restrict a maximum rotation of the twist due to their size and position relative to the spoke. The twist motion may have an incremental increase in resistance to enable feedback and better responsiveness to the operator as a result of the material and spring element design. A drive element may be used to translate the rotation of the outer rim to a rotary or linear encoder or other type of device operable to translate the movement, which may be operable to transmit the rotational input signal based on degrees of twist rotation of the outer rim to the accelerator and braking systems. The drive element may be at least one of, but not limited to a v-belt, a toothed belt, a cable, a multi-link chain, gears or other suitable drive element. Additionally, sprockets may be included at the encoder or the steering wheel rim to aid in the smooth movement of the drive element.

Acceleration and deceleration may be from a servo motor, a stepper motor or other such device, physically connected to the brake and accelerator pedals, or through electronic communication activating electronic throttle and electronic braking systems configured on the motor vehicle. By way of example, an electro-mechanical system having a servo connected to a brake pedal assembly and a servo controller unit will be discussed in greater detail. The servo controller may be configured within the ECM or separate thereof with and in communication with the ECM. The servo controller may run on a “closed loop” communication system to facilitate a programmable position and speed (Position Loop Controller), such that a degree of rotation may equal a specific speed or throttle position as the accelerator pedal may be pulled down by the servo to mimic the operator pressing down to accelerate and propel the vehicle. This servo controller may be configured to various vehicle requirements such as via a USB to laptop or other known vehicle interface connection. Various mounting positions are contemplated, and the exemplary figures illustrate the servo may be mounted to the left of the brake pedal or between the brake and accelerator on the floor of the vehicle under the operating position. A drive shaft extending from the servo may include two spools (bobbins) along the shaft.

A first spool may connect to the brake pedal and the other, a second spool may connect to the accelerator pedal via multi-link chains, cable or other type device able to translate the rotational or linear movement of the servo into movement of the accelerator pedal or brake pedal. Thus, in this example when the servo is rotated in a first direction the chain is wound onto the brake spool/bobbin pulling down the brake pedal while the accelerator pedal chain spools off into a receiver below the accelerator spool/bobbin thereby preventing both the accelerator and brake from being applied at the same time. Reversing the direction to a second, opposite direction operates the accelerator pedal and disengages the brake pedal. The servo, servo shaft, spools, and chains (positioned in the foot-well) may be boxed in a heavy duty IP67 rated enclosure to prevent damage or debris from entering the servo mechanism. The servo controller may be mounted in the steering wheel center utilizing the steering column to supply a route for the wiring harness or it may be positioned under the dash of the vehicle or in any other suitable location. The wiring harness may be a 12-volt positive system with signal wires extending to the servo. The activation button may be any known electronic switch operable to provide power to the BAD system. The activation button can be any type switch, such as, but not limited to a toggle switch, a “Strike Button” or other known device operable to provide power or remove power to the BAD system. The activation button may be positioned anywhere within the vehicle cabin that is convenient for the operator to reach, such as the dash, gear shift or any position on the steering wheel. Merely by way of example in the disclosed figures positioning the activation button in the center of the steering wheel will be discussed. Additionally, the activation button or device may be like an emergency stop button, which may require pulling out to reset and de-energize the BAD system and allow for normal driving utilizing the foot-controlled brake and accelerator pedals or depressed to activate or energize the steering wheel controls. This may be done at any time provided the need to switch from foot controls to hand controls is necessitated.

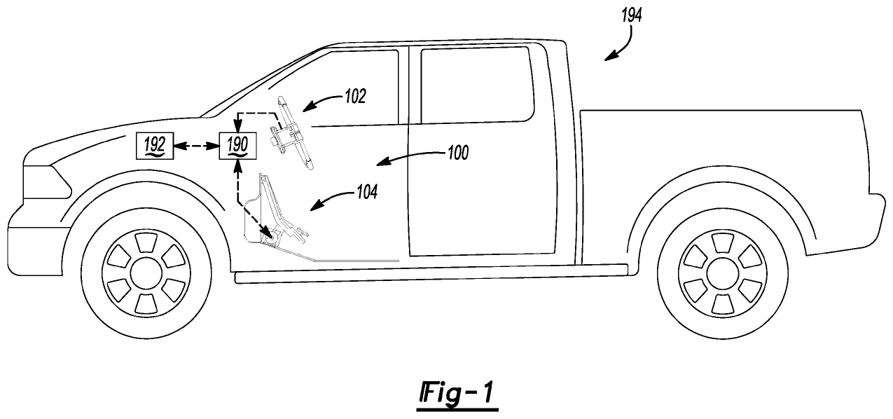

Referring to FIG. 1, a side illustration of an exemplary vehicle having an auxiliary hand brake and hand throttle control system 100 is disclosed. The auxiliary deceleration/brake and acceleration control system 100 also referred to as the BAD system 100. The BAD system 100 includes a steering wheel assembly 102 having integrated twist brake and throttle controls extending about a circumference of the steering wheel assembly 102 that is in communication with an auxiliary brake and acceleration assembly 104, which are both positioned within a vehicle 194 at a driver position (not illustrated). The vehicle 194 may include at least one of an internal combustion drivetrain, an electric drivetrain and a hybrid drivetrain or any other type of drivetrain system that includes a throttle or accelerator (mechanical, electronic or other known system) operable to accelerate the vehicle 194 in a forward and reverse direction and at least one of a hydraulic and an electronic brake system to decelerate or stop the vehicle 194. A user, not illustrated, may accelerate the vehicle 194 the forward or reverse directions by depressing either a common throttle pedal 128 or twisting an outer surface, also referred as a steering wheel twist grip 158 in a first twist or rotational direction, referred herein after as first twist direction 150.

Alternatively, the vehicle 194 may be decelerated or stopped by either depressing a brake pedal 120 or twisting the steering wheel twist grip 158 in a second twist or rotational direction, referred here in after as second twist direction 198. It should be understood that control of the propulsion and/or deceleration/stopping of the vehicle 194 through the steering wheel assembly 102 may be achieved by translating the twist through an encoder 172. A movement of the encoder 172 may transmit a degree of rotation (not illustrated) into movement of the accelerator or the brake system, which will be explained in greater detail below. This movement transmission may be achieved through communication between the encoder 172 and a BAD controller 190 that communicates between a vehicle electronic control module (ECM) 192 and the auxiliary brake and acceleration assembly 104 once an activation button 136 is engaged to power the BAD system 100. Communication between the BAD system 100 and the vehicle 194 may be via hard wire extending between the components or wirelessly via standard wireless protocols, including but not limited to and merely by example, WI-FI, Bluetooth, Global Positioning Systems (GPS), Infrared, Microwave, Radio Frequency, Radio Frequency Identification, UHF and VHF.

While illustrated as one main controller, the controller 192 may be part of a larger control system and may be controlled by various other controllers which may include various embodiments of BAD controller 190, BAD control module 222, and BAD control module 348 configured throughout the vehicle 194, as well as a vehicle system controller (VSC, not illustrated). It should therefore be understood that the controller 192 and one or more other controllers can collectively be referred to as a “controller” that controls various actuators in response to signals from various sensors to control functions in the vehicle 194 or vehicle subsystems. The controller may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 192 in controlling the vehicle 194 or vehicle subsystems.

Control logic or functions performed by the controller 192 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description.

The control logic may be implemented primarily in software executed by a microprocessor-based vehicle, engine, and/or powertrain controller or it may receive a separate signal for acceleration and braking from the BAD controller as discussed in greater detail below. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

The controller 24 may be configured to receive various states or conditions of the various vehicle components illustrated in FIG. 1 via electrical signals. The electrical signals may be delivered to the controller 24 from the various components via input channels. Additionally, the electrical signals received from the various components may be indicative of a request or a command to change or alter a state of one or more of the respective components of the vehicle 10. The controller 24 includes output channels that are configured to deliver requests or commands (via electrical signals) to the various vehicle components. The controller 24 includes control logic and/or algorithms that are configured to generate the requests or commands delivered through the output channels based on the requests, commands, conditions, or states of the various vehicle components.

The input channels and output channels are illustrated as dotted lines in FIG. 1. It should be understood that a single dotted line may be representative of both an input channel and an output channel into or out of a single element. Furthermore, an output channel out of one element may operate as an input channel to another element and vice versa.

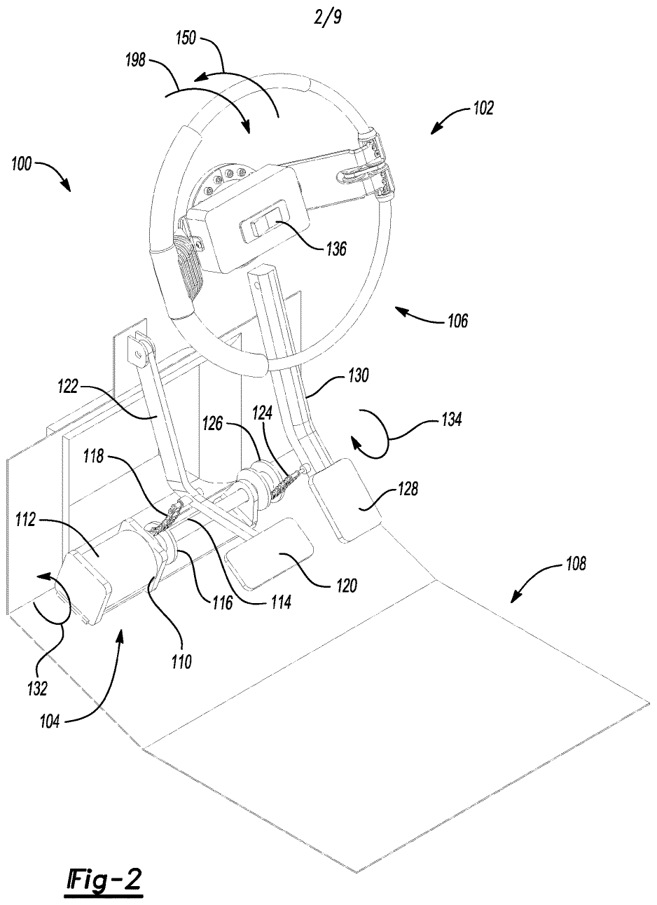

Turning to FIG. 2, the exemplary perspective view of the BAD system 100 of FIG. 1 is illustrated. Specifically, the BAD system 100 may include the steering assembly 102 which includes a steering wheel 106 and the activation button 136, that as an example is positioned in the middle of the steering wheel 106. However, as mentioned above, this activation button 136 may be positioned anywhere around the operator that is convenient to reach. Additionally, activation button 106 may be of any type of button that when engaged provides power from the vehicle 194 charging system (not illustrated) to the brake and acceleration assembly 104 mounted to an interior vehicle body panel 108. The interior vehicle body panel 108 may be at least one of a floorboard, firewall or any other vehicle body component adjacent the brake and acceleration assembly 104. The brake and acceleration assembly 104 may include a servo 112 that, when energized is operable to either rotate in the case of a rotary actuator or slide linearly in the case of a linear actuator.

For illustration purposes the servo 112 is and will be referred to hereinafter as the rotary actuator 112, which is attached to the floorboard body panel 108 with a mount 110. The mount 110 supports the rotary actuator 112 at a first end and a second end (not illustrated) to maintain alignment of a shaft 114 extending from the second end of the actuator 112. As illustrated, the shaft 114 may be slid through and support a brake spool 116 near the rotary actuator 112 and an accelerator spool 124 at a distal end of the shaft 114. The brake spool 116 may be interconnected between the shaft 114 and a brake pedal 120 or a brake mounting arm 122 via a brake linkage element 118 and ultimately connected to a vehicle braking mechanism (not illustrated).

As discussed above, when the actuator 112 is rotated in a first direction 132 the brake linkage 118 is wrapped around the brake spool 116 causing the brake pedal 120 and brake mounting arm 122 to become depressed, thereby decelerating or stopping the vehicle 194. However, rotation of the actuator 112 in the opposite or a second rotational direction 134, the accelerator spool 124 may be interconnected between the shaft 114 and an accelerator pedal 128 or an accelerator mounting arm 130 via an accelerator linkage element 126 and ultimately connected to a vehicle acceleration mechanism, not illustrated. The rotary actuator 112 may be positioned between the brake mounting arm 122 and the accelerator mounting arm 130 such that the shaft 114 extends through and protrudes from both ends of the actuator allowing the brake spool 116 to be positioned at one end of the shaft 114 (not illustrated) and the accelerator spool 124 to be positioned on an opposite end of the shaft 114 (not illustrated).

Additionally, as discussed above, when an operator grasps the steering wheel 102 and twists or rotates the steering wheel in a first twist direction 150 the BAD controller 190 receives the signal from the rotary encoder 172 and sends a signal to the actuator 112 to rotate. The rotation of the shaft 114 and spool 124 in the second rotation direction 134 results in wrapping the accelerator linkage 126 around the spool 124 thereby causing the accelerator pedal 128 and accelerator mounting arm 130 to depress, accelerating the vehicle 194 in the forward or reverse direction. Conversely, when the operator rotates or twists the steering wheel 102 in a second twist direction 198 the brake spool 116 rotates in the first rotation direction 132 causing the brake linkage 118 to wrap around the brake spool 116 pulling the brake arm 122 and engaging the brakes to decelerate or stop the vehicle 194. It should be understood that as the shaft 114 rotates in the first direction 132 the brake linkage 118 is wrapped around the brake spool 114 while simultaneously loosening or unwinding the accelerator linkage 124 loosens. Alternatively, when the shaft 114 is rotated in the second rotation direction 134 the accelerator linkage 124 is wrapped around the spool 126 and the brake linkage 118 is unwrapped from the spool 114. However, when the operator either removes their hands from steering wheel 106 or fails to twist the steering wheel twist grip 158, the grip 158 will be in a neutral position, which may automatically apply a positive brake position to prevent vehicle creep due to a torque from the drivetrain components (not illustrated). The application of the positive brake is optional and dependent on the need of operator and such that the operator may require the system be adjusted to set a greater positive brake position, a reduced positive brake position or no positive brake application at all.

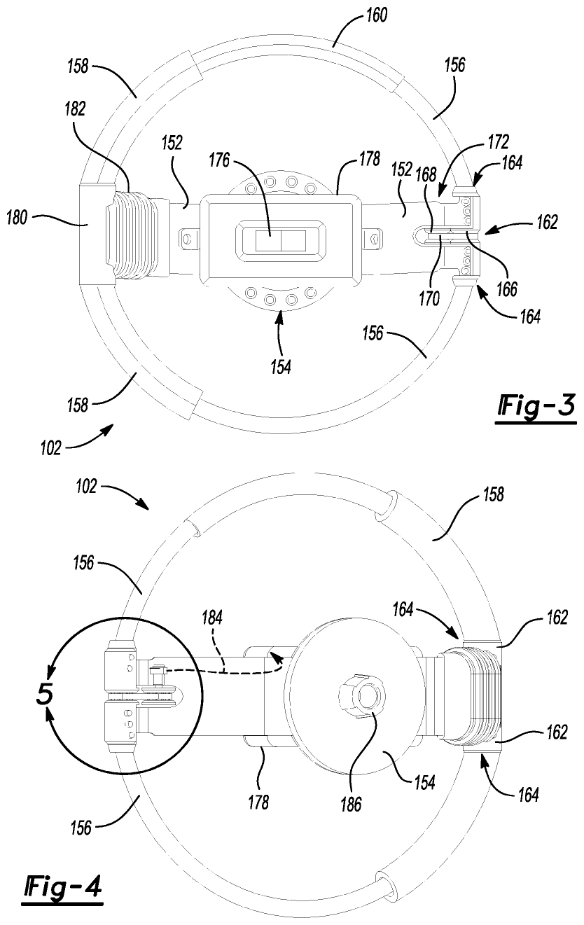

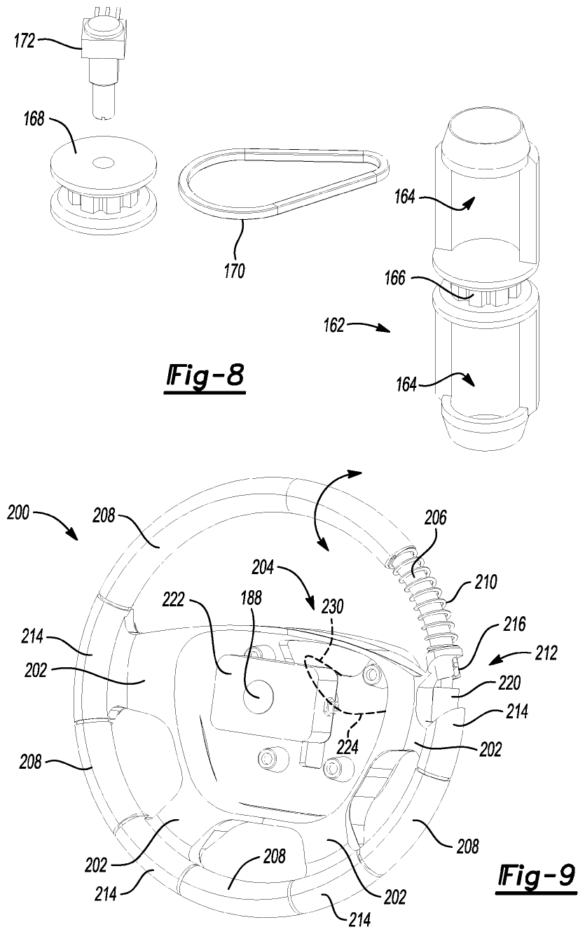

Turning to FIGS. 3-8 various exemplary views and details of the exemplary cut-away steering wheel assembly are illustrated. Specifically, in FIG. 3, a front view of the cut-away steering wheel assembly 102 is illustrated. As can be seen, the steering wheel 106 includes a steering wheel core 156 that extends between and is supported by at least one steering wheel spoke 152 that radiate from a steering wheel center hub 154. As discussed above, the steering wheel twist grip 158 is rotatably attached to steering wheel core 156 and operable to twist about the steering wheel core 156. In some instances, a resilient member or referred to herein after as a steering wheel twist tube 160 may be necessary to allow the steering wheel twist grip 158 to spring back to a neutral position (not illustrated). As discussed above, the steering wheel twist tube 160 may be any springing element that when twisted returns to its neutral position or is pulled back to it's neutral position by a springing characteristic. This resiliency provides the operator with a tactile feedback when they twist the steering wheel twist grip 158 in the first 150 or second 198 directions while returning the twist grip 158 to the neutral position when an operator removes their hands or loosens their grip from the steering wheel 106.

With further reference to FIGS. 3-8, the steering wheel spokes 152 are attached to the steering wheel hub 154 and the steering wheel core 156 through the use of fasteners 196. However, prior to fastening the steering wheel core 156 to the spokes 152, the core 156 may be inserted into a twist bearing housing assembly 162. The twist bearing housing assembly 162 may include at least one bearing 164 to allow for smooth twist rotation and translation of the rotation to a drive belt hub or first gear 166. The first gear 166 may be integrated with or attached to the twist bearing housing assembly 162 and is operable to rotate when the steering wheel twist grip 158 is rotated. The rotation is translated to the rotary encoder 172 through a drive element or drive belt 170 that extends over the first gear 166 to and around a second gear 168. The second gear 168 is attached to and operable to transfer the rotary motion of the first gear 166 to the encoder 172, which transmits the signal to the BAD controller 190 and ultimately to the brake and acceleration assembly 104 or in the case of an electronic or drive by wire vehicle 194, to the vehicle electronic control module 192. Additionally, the twist bearing housing assembly 162 may include a plurality of at least one bearing 164, as illustrated, two bearings 164 are included at each end of the twist bearing housing assembly 162 and it is contemplated that a third bearing 164 may be inserted at a midpoint to further support the smooth rotation of the first gear 166.

The steering wheel 106 may also include a communication line 174 that extends between the rotary encoder 172 and at least, the BAD controller 190, as discussed above. Additionally, as illustrated the switch 176 is positioned in a switch housing 178 mounted via switch housing mounting tabs 188 above the steering wheel center hub 154. As discussed, the switch 176 and switch housing 178 may be mounted anywhere within the vehicle that is convenient for an operator to reach and activate the BAD system 100. A twist bearing housing cover 180 and a drive belt assembly cover 182 are both included to further protect the twist bearing housing assembly 162, the rotary encoder 172, the drive gears 166, 168 and the drive belt 170 from the environment. This may prevent damage to the components and thereby may prevent false twist translation signals being sent to the BAD controller 190. It should be understood that to translate the twist created by the operator from the steering wheel twist grip 158 or the steering wheel twist tube or resilient member 160 there may be a connection, attachment with or insertion into the twist bearing housing 162, similar to the insertion of the steering wheel core 156. As previously, discussed the twist bearing housing 160 may translate the rotational twist created by the operator into movement of the encoder 172, which in-turn may create the electrical signal for communication to accelerate or decelerate/stop the vehicle.

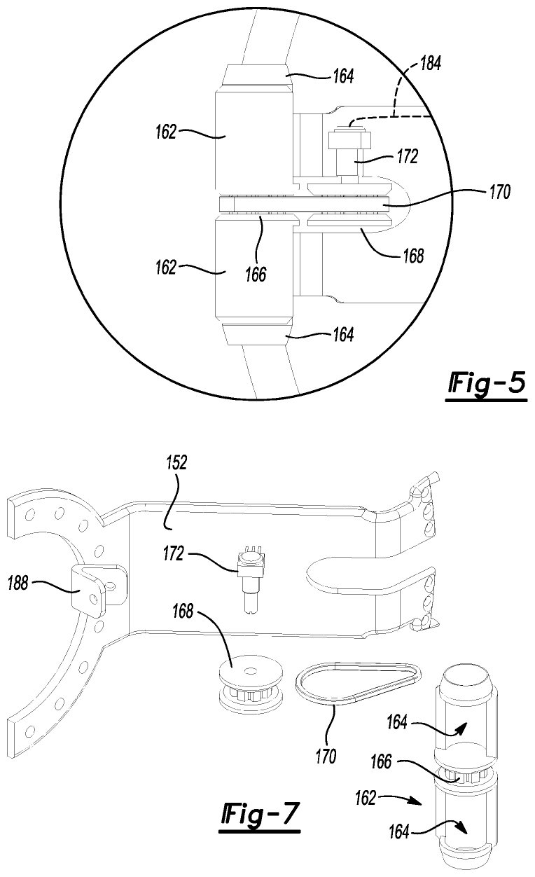

Turning specifically to FIGS. 4 and 5, an exemplary detail view of the rear of the steering wheel assembly 102 is illustrated. Specifically, the steering wheel core 156 inserted into the twist bearing housing assembly 162 at twist bearings 164 located at the ends of the housing assembly 162 with the rotary encoder 172 attached to a back side of one of the steering spokes 152. Additionally, it should be realized that both sides of the steering wheel assembly 102 may be a mirror image with twist bearing housing assembly 162 being positioned whenever the steering spoke 152 intersects with the steering wheel core 156 and in some instances the gears 166 and 168 along with a second rotary encoder 172 may be used but may not be necessary. Accordingly, one can understand the connection and movement created between the steering wheel core 156, steering wheel twist grip 158 and the twist bearing housing assembly 162 for translating smooth twist rotation through the two gears 166, 168 and the drive belt 170 to the rotary encoder 172. Thus, as the operator twists the steering wheel twist grip 158 that is attached to twist bearing housing assembly 162 and twist bearings 164, the twist is translated through the first gear 166 via the belt 170 to the second gear 168 to the rotary encoder 172 to translate the twist into movement or stopping of the vehicle 194.

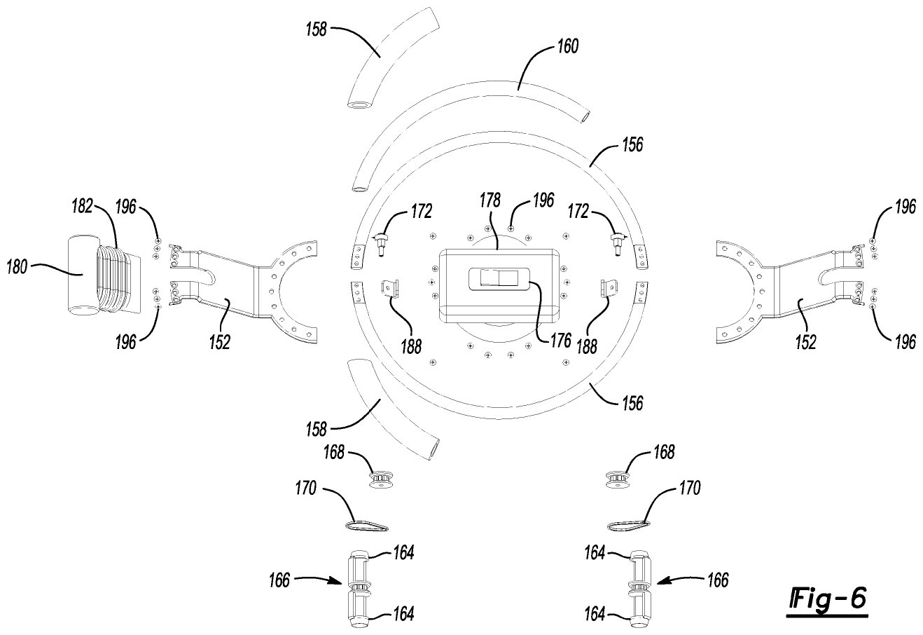

With continued reference to FIGS. 3-6 the steering wheel center hub 154 is connected to a steering column (not illustrated) of the vehicle 194 through the use of a steering wheel hub spline 186. Additionally, the steering wheel center hub 154 and the steering wheel spokes 152 are illustrated as separate pieces connected together with the fasteners 196. These components may be constructed as a single unit or the two steering wheel spokes 152 may be constructed as a single unit and affixed either permanently or removably to the center hub 154. Additionally, with specific reference to the exploded view of FIG. 6, the exemplary illustration demonstrates the layout of utilizing rotary encoders 172 on both sides where the twist bearing assembly 162 is located. Additionally, the detail of each component of the exemplary steering wheel assembly 102 is illustrated. However, it should be understood that a single steering wheel spoke 152 may radiate from the steering wheel hub 154 to connect the steering wheel core 156 (not illustrated). When a single spoke 152 is utilized then a single twist bearing housing assembly 162 with the two gears 166, 168, single drive belt 170 and single rotary encoder 172 may be used.

Turning now to FIGS. 9-11, various cut-away views of an alternative exemplary steering wheel assembly 200 are illustrated. The steering wheel assembly 200 may include a plurality of steering wheel spokes 202 extending radially from a steering wheel center hub 204. As illustrated, the steering spokes 202 support a steering wheel core 206, which is connected to the spokes at a twist bearing assembly 212. The twist bearing assembly 212 may include a universal joint 216 connected on or machined into the end of the steering wheel core 206 and positioned within a twist bearing housing 214. The steering wheel assembly 200 may also include a rotating coil or spring, also known as a twist tube 210 positioned over and extending around the steering wheel core 206. The rotating coil twist tube spring 210 may include an outer cover or twist grip 208 operable to twist laterally around the steering wheel core 206 in a forward and reverse direction by an operator (not illustrated). The operation of the steering wheel assembly 200 is similar to the operation defined above with regarding to FIGS. 1-8. However, the rotating coil 210 may provide additional resistance that may be tuned to be tighter or looser through the use of a collar (not illustrated) mounted to the twist bearing housing 214. This may provide a greater tactile resistance or response to an operator when twisting the steering wheel twist grip 208 in the forward or reverse directions. Additionally, the twist bearing assembly 212 may include a twist bearing 218 inserted at an entry and exit (not illustrated) of the twist bearing housing 214 that is operable to make the twist rotation move more smoothly. The universal joint 216 may be provided to prevent any binding at the connection between the twist grip 208, the twist tube spring 210 and the twist bearing housing 214 due to the angle of the steering wheel core 206 arc as it connects at the twist bearing housing 214 and the encoder 220. The twist bearing 218 may be a roller bearing, a ball bearing, a brass sleeve or other known bearing element.

Like the description above regarding steering wheel assembly 102, steering wheel assembly 200 includes an encoder 220 that may be operably engaged with a portion of the universal joint 216 or a portion extending therefrom and hidden within the twist bearing housing 214. The encoder 220 translates any rotational twist created by an operator into an electric signal that may travel through an encoder communication line 224 to a BAD control module 222 once the BAD control module 222 is energized via a switch 226. It should be understood that the BAD control module 222 may be the same component as BAD controller 190 and is merely numbered separately in the alternative embodiment. The BAD control module 222 and the switch 226 may be positioned remote of the steering wheel assembly 200 or mounted to the steering wheel center hub 204 using a housing 228. Additionally, the BAD control module 222 may be connected to the vehicle 194 ECM 192 and the brake and acceleration assembly 104 through a drive communication line 230. As previously discussed, these components are used to accelerate and decelerate or stop the vehicle utilizing the twisting movement of the steering wheel twist grip 208 by the operator who twists the steering wheel twist grip 208 in the first rotational direction 150 to accelerate the vehicle either forward or backward, depending on the driveline selection, and twist the twist grip in the second rotational direction 198 to decelerate or stop the vehicle 194.

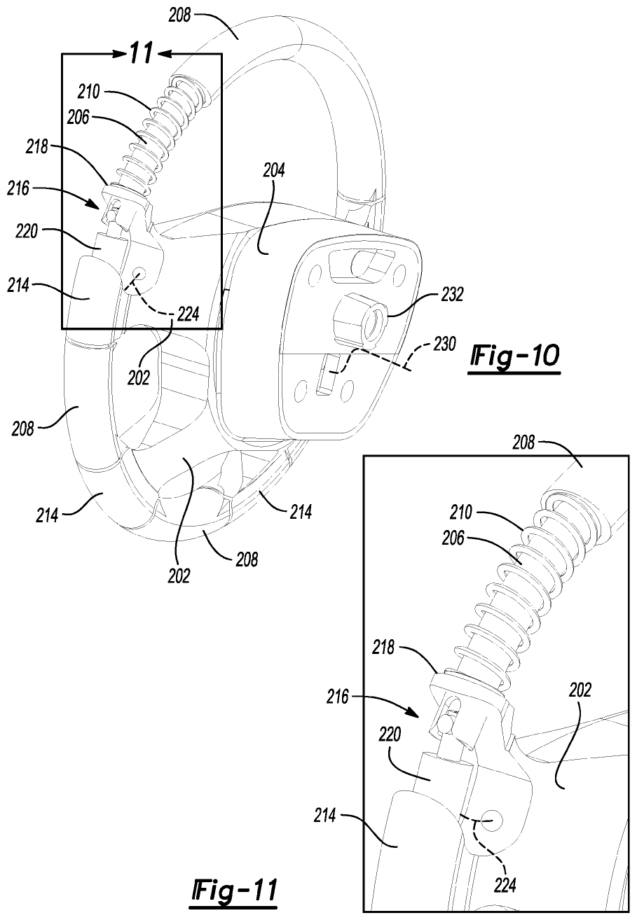

Turning specifically to FIGS. 10 and 11, greater detail through the cut-away is illustrated thereby showing the twist bearing assembly 212 and the positioning of the steering wheel core 206 and the universal joint 216 connected to the encoder 220. From this view one can understand the layout and interconnection of the steering wheel twist grip 208 and its relationship with the twist tube or spring 210 positioned between the grip 208 and the steering wheel core 206 along with a clearance gap that may allow the twist rotation to work more smoothly. Alternatively, a self-lubricating sleeve (not illustrated) may be included between the twist tube or spring 210 and the steering wheel core 206 to aid in the smooth operation and function of the twist. Additionally, the steering wheel center hub 204 may include a mounting hub spline 232 integrated on a backside 232. The mounting hub spline 232 may be mounted to the vehicles 194 steering column (not illustrated) and may include a wiring harness (not illustrated) that extends down the column to house and protect the drive communication line. Further, it should be understood that, as illustrated, the steering wheel center hub 204, steering wheel spokes 202 and the steering wheel hub spline 232 may be constructed as a single casting that is machined to the specific shape, a stamped or machined plate bent, cut or welded to the specific shape or it may be separate components fastened together to create the specific shape.

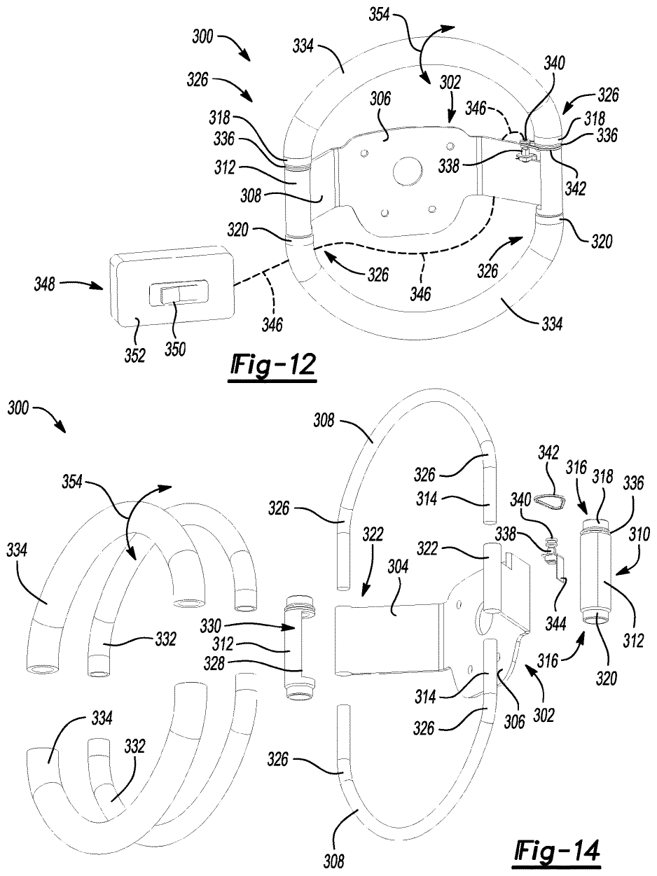

Attention is now drawn to FIGS. 12-14, where various perspective and partially exploded views of an alternative exemplary steering wheel assembly 300 are illustrated. The steering wheel assembly 300 may include a steering unit 302 that may include at least one steering wheel spoke 304 extending radially from a steering wheel center hub 305. As illustrated, the steering unit 302 is constructed of a stamped metallic base having the center hub 306 with two steering spokes 304 being bent out at a predetermined angle (not illustrated). As discussed previously, this steering unit 302 may be constructed of a casting, bent and/or welded metallic components, a high-density polymer other such materials that are configured to meet government standards for a steering wheel assembly 300. The two steering spokes 304 extend out from the center hub 306 and are connected to and configured to support at least one steering wheel core 308 that may extend at least partially radially around a steering unit central axis (not illustrated) and is connected to the steering wheel spokes 304 at a twist bearing assembly 310. As previously discussed, the connection may be through fasteners or adhesives that provide enough strength to connect the steering wheel core 308 to at least a portion of the steering wheel spoke 304.

Turning to the twist bearing assembly 310, which may include a twist bearing housing 312, a twist bearing 316, and a steering core connection sleeve 322. Alternatively, the steering core connection sleeve 322 may be integrated onto the steering unit 302 as an integral part of the steering wheel spokes 304 to further support the steering wheel core 308. The steering core connection sleeve 322 may receive and join the ends of the steering wheel core 308 to provide additional rigidity to the connection joint 324. Additionally, to further improve the connection the steering wheel core 308 may include a bend 326 to transition the arced profile of the steering wheel core 308 into more of a straight line or straight section 314 that matches the profile of the steering connection sleeve 322.

The twist bearing housing 312 may include at least one twist bearing 316 inserted int at least one of a housing top end 318 and a housing bottom end 320 with the steering core connection sleeve 322 positioned therebetween. The twist bearing housing 312 may also include a cutout 328 on a cutout inner side 330 adjacent the steering wheel spoke 304 when assembled. The cutout 328 all provides a relief area that allows the twist bearing housing 312 to rotate a predetermined distance without interference from the steering wheel spoke 304. The twist bearing housing 312 may be operable to allow an end of the steering wheel core 308 to slide through the housing top end 318, through the twist bearing 316 and into the steering core connection sleeve 322. Note that the connection between the steering wheel core 308 and the twist bearing 316 may be an interference or press fit to allow the twist bearing housing 312 to rotate over the steering wheel core 308 and the steering core connection sleeve 322.

Rotation of the twist bearing housing 312 is the result of at least one of a steering wheel twist tube 332 and a steering wheel twist grip 334 being positioned over the steering wheel core 308 and affixed to the steering wheel twist housing 312. Alternatively, the steering wheel twist grip 334 and the steering wheel twist tube 332 may be slid over the steering wheel core 308 prior to the steering wheel core 308 being assembled with the twist bearing assembly 310. Alternatively, the steering wheel twist tube 332 may be lined with a self-lubricating coating or separate lining (not illustrated) to aid in the smooth rotation during operation. Additionally, the steering wheel twist tube 332 and the steering wheel twist grip 334 may be operable to rotate or twist by a user as previously discussed above. Specifically, when an operator grasps the twist grip 334 the grip may be operable to twist laterally around the steering wheel core 308 in a forward and reverse direction by an operator signified by a twist arrow 336.

The operation of the steering wheel assembly 300 is similar to the operation defined above with regarding to FIGS. 1-11, in that when the operator grasps and rotates then at least one of the steering wheel grip and the steering wheel twist tube 332 will rotate about the steering wheel core 308 transferring the rotative movement to the twist bearing assembly 310. The movement of the twist bearing assembly 310 translates into rotation of the twist bearing housing 312, which may include a twist gear or channel 336, and an encoder 338 having an encoder gear or channel 340 that is interconnected with the twist gear 336 through a drive belt 342 or other drive element, such as, but not limited to a v-belt, chain, cable or other such element to translate a twist of the steering wheel grip 334 into an electric signal (not illustrated). The encoder 338 is supported be an encoder bracket 344 that may be attached to the steering wheel spoke 304.

Like the description above, the encoder 338 translates any rotational twist created by an operator into an electric signal that may travel through an encoder communication line 346 to a BAD control module 348 once the BAD control module 348 is energized via a switch 350. It should be understood that the BAD control module 348 may be the same component as BAD controller 190 and BAD Control Module 222 and is merely numbered separately in the alternative embodiments. The BAD control module 348 and the switch 350 may be positioned remote of the steering wheel assembly 300 or mounted to the steering wheel center hub 306 using a housing 352. Here, the BAD control module 348 is remote of the steering wheel assembly 300. Additionally, the BAD control module 348 may be connected to the vehicle 194 electronic control module 192 and the brake and acceleration assembly 104 through a drive communication line (not illustrated). As previously discussed, these components are used to accelerate and decelerate or stop the vehicle utilizing the twisting movement of the steering wheel twist grip 334 by the operator who twists the steering wheel twist grip 334 in the first rotational direction 150 to accelerate the vehicle either forward or backward, depending on the driveline selection, and twist the twist grip in the second rotational direction 198 to decelerate or stop the vehicle 194 this first rotational direction 150 and second rotational direction 198 are annotated as twist directions 354.

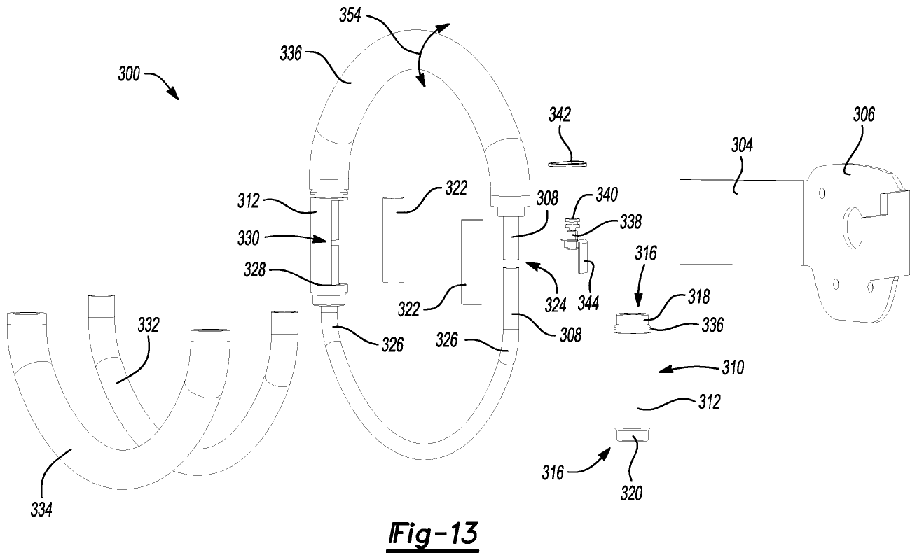

Turning specifically to FIGS. 13 and 14, the detail, partial exploded and cut-away views illustrate greater detail of the components and how they interconnect. Specifically, how the steering wheel core 308 is interconnected and a possible method of assembly where the steering wheel core 308 is bent 326 to provide a straight section 314, then the steering wheel twist tube 332 and twist grip 334 are either slid onto the steering wheel core 308 and then the ends are slid into the twist bearing housing, twist bearing and joined with the steering core connection sleeve 322 at the steering wheel connection joint 324 to create the steering wheel assembly. Alternatively, the twist tube 332 and the twist grip 334 may be over molded once the twist bearing assembly 310 and steering unit 302 are interconnected.

It should be understood that the designations of first, second, third, fourth, etc. for any component, state, or condition described herein may be rearranged in the claims so that they are in chronological order with respect to the claims. Additionally, the different embodiments disclosed herein may be implemented individually or in any combination, the specific arrangements are examples and do not limit any combination.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a steering wheel having an outer cover operable to twist in at least one of a first direction and a second direction;
a braking system operable to at least one of decrease a speed of the vehicle and stop the vehicle;
a throttle system operable to increase the speed of the vehicle; and
a controller programmed to,
in response to twisting the steering wheel outer cover in the first direction, operate the throttle system to increase the speed of the vehicle, and
in response to twisting the steering wheel outer cover in the second, direction, operate the braking system to decrease the speed of the vehicle.

2. The vehicle according to claim 1, wherein the steering wheel further comprising: a central hub connected to a vehicle steering linkage, at least one spoke extending from and radiating outwardly from the central hub, a cylindrical core affixed to the at least on spoke and extending about the central hub and a self-lubricating sleeve extending around an outside surface of the cylindrical core.

3. The vehicle according to claim 2, further comprising: a torsional element extending at least partially about the outside surface of the cylindrical core and operatively connecting a signal encoder, wherein the torsional element engages the steering wheel outer cover and translates the twisting of the first direction and the second direction into an electronic signal communicating with the controller.

4. The vehicle according to claim 1, further comprising: a drive motor in communication with the controller and operatively connected to at least one of a brake pedal and an acceleration pedal.

5. The vehicle according to claim 4, wherein the drive motor is configured to rotate in a first direction to apply pressure to the brake pedal and a second opposite direction to apply pressure to the acceleration pedal.

6. The vehicle according to claim 5, wherein the drive motor is configured to rotate in the first direction to apply an initial pressure to the brake pedal when an activation device is engaged to activate the controller.

7. The vehicle according to claim 1, wherein an activation device is a secondary switch and is not an ignition switch that controls an engine of the vehicle.

8. A steering wheel comprising:
a center hub configured to attach to a vehicle;
at least one steering spoke extending outward from the center hub and configured to support at least one steering wheel core, wherein the steering wheel core extends at least partially radially around a central axis of the center hub; and
at least one twist assembly positioned about the at least on steering wheel core, wherein twist assembly is operable to twist about the steering wheel core in at least one of a first direction and a second direction, the second direction opposite the first direction,
wherein a movement of the twist assembly in the first direction increases a speed of the vehicle and a movement of the twist assembly in the second direction decreases the speed of the vehicle.

9. The steering wheel according to claim 8, wherein the twist assembly includes a twist bearing housing configured to receive and support and a twist bearing, the twist bearing having an aperture operable to engage an end of the steering core.

10. The steering wheel according to claim 9, wherein the twist assembly further includes a twist tube configured about an outer surface of the steering wheel core, and a twist grip positioned around the twist tube, and wherein at least one of the twist tube and the twist grip are configured to engage at least a portion of at least one of the twist bearing and the twist bearing housing.

11. The steering wheel according to claim 10, further comprising an encoder in communication with at least one of the twist bearing housing and the twist bearing through a drive element, the drive element configured to translate the movement of the twist assembly of the first direction and the second direction to the encoder, wherein the encoder communicates at least one of an acceleration signal or stop signal to a controller based on encoder rotation direction.

12. The steering wheel of claim 8 further comprising a controller, wherein the vehicle further includes an accelerator pedal, and wherein the controller is programmed to,
in response to depressing the accelerator pedal, increase a speed of the vehicle at a first rate, and
in response to movement of the twist assembly in the first direction, increase a speed of the vehicle at a second rate that is less than the first rate.

13. The steering wheel of claim 8 further comprising a controller, wherein the vehicle further includes a brake pedal, and wherein the controller is programmed to,
in response to depressing the brake pedal, decrease a speed of the vehicle at a first rate, and
in response to movement of the twist assembly in the second direction, decrease a speed of the vehicle at a second rate, wherein an absolute value of the second rate is less than an absolute value of the first rate.

14. A method of operating a motor vehicle comprising the steps of:
providing a twist grip steering assembly, wherein the twist grip steering assembly includes a steering wheel attached to a motor vehicle, the steering wheel having a hub, a steering wheel core connected to the hub, a torsional member positioned around the steering wheel core, a twist grip positioned around and connected to the torsional member, an encoder operatively connected to at least one of the torsional member and the twist grip and a controller operatively connected to the encoder;
twisting the twist grip in at least one of a first direction thereby rotating the encoder in a first encoder direction to generate an acceleration signal;
sending the acceleration signal to at least one of the controller and a servo motor in communication with an accelerator to accelerate the vehicle;
twisting the twist grip in at least one of a second and opposite direction to the first direction thereby rotating the encoder in a second encoder direction, opposite the first encoder direction to generate a braking signal; and
sending the braking signal to at least one of the controller and the servo motor to brake the vehicle.

15. The method of operating a motor vehicle according to claim 14, wherein the connection of the twist grip steering assembly is at least one of slid onto the steering wheel core or vulcanized thereto the steering wheel core

16. The method of operating a motor vehicle according to claim 14, wherein the rotation of the encoder in at least one of the first encoder direction and the second encoder direction is at least one degree of rotation.

17. The method of operating a motor vehicle according to claim 14, further comprising the step of: providing an activation button, wherein the activation button provides power to the twist grip steering assembly to allow an operator to accelerate and stop the motor vehicle by twisting the twist grip.

18. The method of operating a motor vehicle according to claim 14, further comprising the step of: twisting the twist grip in the first direction to accelerate the vehicle forward, wherein the greater the degree of rotation forward the faster the vehicle will accelerate.

19. The method of operating a motor vehicle according to claim 15, further comprising the step of: twisting the twist grip in the second direction to stop the vehicle, wherein the greater the degree of rotation in the second direction the faster the vehicle will stop.

20. The method of operating a motor vehicle according to claim 14, further comprising the step of: engaging the brakes once the activation button is activated a signal is sent to the brake mechanism to provide a positive brake to prevent the vehicle from moving without the operator engaging the twist grip in the event the operator is incapacitated and a second operator engages and activates the activation button.
